(19) United States
(12) Patent Application Publication
(10) Pub. No.: US 2015/0183046 A1
(43) Pub. Date: Jul. 2, 2015

(54) STUD WELDING DEVICE AND WELDING METHOD USING THE SAME

(71) Applicant: SUNGWOO HITECH CO., LTD., Busan (KR)

(72) Inventor: Gwang Hyun KIM, Busan (KR)

(73) Assignee: SUNGWOO HITECH CO., LTD., Busan (KR)

(21) Appl. No.: 14/250,477

(22) Filed: Apr. 11, 2014

(30) Foreign Application Priority Data
Dec. 31, 2013 (KR) 10-2013-0169444
Dec. 31, 2013 (KR) 10-2013-0169447

(51) Int. Cl. B23K 9/20

(52) U.S. Cl. CPC B23K 9/201

(57) ABSTRACT

A stud welding device may include: a gun frame; a transformer disposed at a side of a rear portion of the gun frame and supplying welding current; a pressing cylinder mounted at a front portion of the gun frame and including an operating rod; a cooling holder mounted at a front end of the operating rod of the pressing cylinder; a stud welding tip mounted at a front end of the cooling holder and formed of an inserting hole in which negative pressure is applied; and an electric cable connected to one side of the operating rod of the pressing cylinder and applying the current of the transformer to the stud welding tip, wherein the stud welding device is adapted to execute resistance welding by applying pressure and the current to the base metal in a state of mounting a stud bolt at the stud welding tip using the negative pressure in the inserting hole.

### CROSS-REFERENCE TO RELATED APPLICATION

This application claims priority to and the benefit of Korean Patent Application Nos. 10-2013-0169444 and 10-2013-0169447 filed in the Korean Intellectual Property Office on Dec. 31, 2013, the entire contents of which are incorporated herein by reference.

### BACKGROUND OF THE INVENTION

(a) Field of the Invention

The present invention relates to a stud welding device and a welding method using the same. More particularly, the present invention relates to a stud welding device and a welding method using the same that welds a stud bolt to a base metal by pressing the stud bolt onto the base metal and applying current thereto in a state of mounting the stud bolt at stud welding tip using negative pressure.

(b) Description of the Related Art

Generally, a stud welding method is the newest welding method using basic principles of arc welding and resistance welding. According to the stud welding method, a stud bolt (i.e., annular rod or bolt) is deposited onto a base metal without boring the base metal. The stud welding method is one of the most ideal and economical joining method which can meet strict joining conditions in an industry field requiring high strength joining.

According to the stud welding method, the stud bolt of metal material is inserted into the base metal axially and is welded to the base metal. In further detail, the stud bolt supplied to a stud chuck is contacted to the base metal and current is applied to the stud bolt and the base metal through the stud chuck so as to generate strong arc between the stud bolt and the base metal. Therefore, an end portion of the stud bolt and the base metal are melted. At this state, the stud bolt is inserted into the base metal and a molten portion is coagulated. Therefore, the stud bolt and the base metal are joined together.

FIG. 1 is a perspective view of a stud chuck of a conventional stud welding device.

Referring to FIG. 1, a conventional stud welding device includes a stud gun 101 provided with a pressing cylinder (not shown) therein and a stud chuck 105 mounted at an end portion of the stud gun 101 through an adapter 103.

A stud supply pipe 107 is connected to a side of the stud chuck 105 through a receiver 109.

A stud bolt S supplied through the stud supply pipe 107 is supplied to the stud chuck 105 through the receiver 109 in the stud welding device.

If the pressing cylinder pushes the stud bolt S to contact with a welding portion W of the base metal 100 and current is applied to the stud bolt S at this state, arc is generated and a portion of the base metal 100 and the stud bolt S is melted. Therefore, the stud bolt S is inserted and deposited into the base metal 100 so as to be welded at a desired position of the base metal 100.

Meanwhile, a sustainer 111 is provided at a side of the stud gun 101 and is adapted to support the base metal 100 when stud welding.

FIG. 2 is a perspective view of a welding portion that is welded by a conventional stud welding device.

If the welding is done by using the conventional stud welding device, as shown in FIG. 2, plating coated on surfaces of the base metal 100 and the stud bolt S is burnt imperfectly and hydrocarbon grains are scattered when melting the plating by welding heat. Therefore, soot 200 occurs around the welding portion W of the base metal 100 and appearance of the welding portion W becomes bad. In addition, fine spatter is adhered to the surface of the base metal 100.

The soot 200 and fine spatter adhered to the surface of the base metal 100 deteriorate adhesive force of painting in painting process such that painting film may be separated and painting quality and appearance may be deteriorated.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a stud welding device and a welding method using the same having advantages of preventing occurrence of soot on a base metal and improving painting quality and appearance of the base metal as a consequence that a stud holt is welded to the base metal by applying pressure and current to the base metal in a state of mounting the stud bolt at stud welding tip by negative pressure.

A stud welding device according to an exemplary embodiment of the present invention may include: a gun frame; a transformer disposed at a side of a rear portion of the gun frame and supplying welding current; a pressing cylinder mounted at a front portion of the gun frame and including an operating rod; a cooling holder mounted at a front end of the operating rod of the pressing cylinder; a stud welding tip mounted at a front end of the cooling holder and formed of an inserting hole in which negative pressure is applied; and an electric cable connected to one side of the operating rod of the pressing cylinder and applying the current of the transformer to the stud welding tip, wherein the stud welding device is adapted to execute resistance welding by applying pressure and the current to the base metal in a state of mounting a stud bolt at the stud welding tip using the negative pressure in the inserting hole.

The inserting hole of the stud welding tip may be connected to a negative pressure path so as to form the negative pressure therein.

The negative pressure path may be connected to a vacuum pump through a negative pressure pipe.

A front end surface of the stud welding tip may be closed by a head portion of the stud bolt such that vacuum pressure is formed in the stud welding tip.

The stud welding tip may be cooled by coolant supplied from the cooling holder.

The stud welding tip may be press-fitted into a front end of the cooling holder.

A welding method according to another exemplary embodiment of the present invention may include: forming negative pressure in a stud welding tip mounted at a front end of a stud welding gun; mounting the stud bolt at a front end of the stud welding tip by positioning the front end of the stud welding tip in which the negative pressure is formed above the stud bolt; positioning the stud bolt mounted at the stud welding tip on a welding portion of a base metal to which the stud bolt will be bonded; and bonding a head portion of the stud bolt to the base metal by resistance heat by pressing the head portion of the stud bolt onto the welding portion of the base metal and applying current thereto.

The stud welding tip may be formed of an inserting hole having an opened lower portion into which the stud bolt is inserted, and the inserting hole may be connected to a negative pressure path so as to form the negative pressure therein.

The negative pressure path may be connected to an exterior vacuum pump.

The head portion of the stud bolt that may be mounted at the inserting hole by suction force of the negative pressure closes the inserting hole such that the stud welding gun holds the stud bolt by vacuum pressure formed in the stud welding gun.

The stud welding tip may be mounted at a cooling holder provided at a front end of the stud welding gun and is cooled by coolant.

### BRIEF DESCRIPTION OF THE DRAWINGS

FIG. 1 is a perspective view of a stud chuck of a conventional stud welding device.

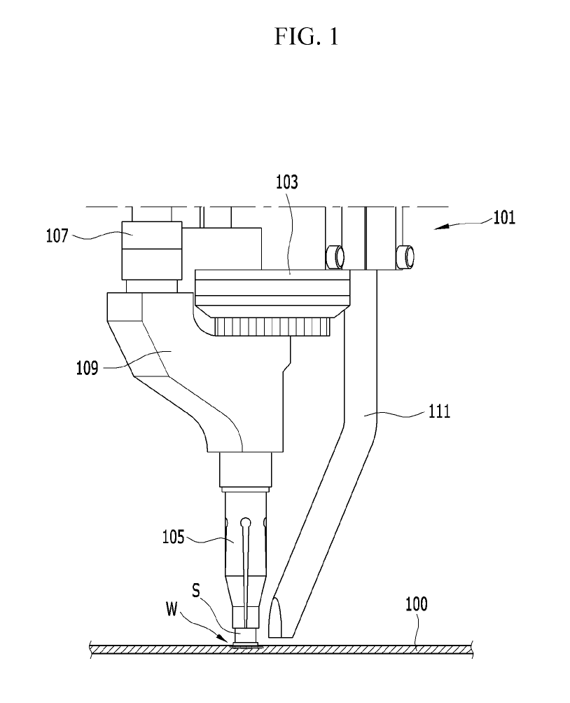

FIG. 2 is a perspective view of a welding portion that is welded by a conventional stud welding device.

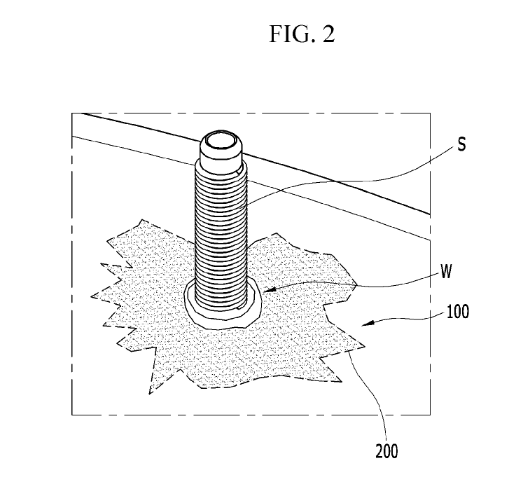

FIG. 3 is a perspective view of a stud welding device according to an exemplary embodiment of the present invention.

FIG. 4 is a side view of a stud welding device according to an exemplary embodiment of the present invention.

FIG. 5 is a partial side view of a stud gun used in a stud welding device according to an exemplary embodiment of the present invention.

FIG. 6 is a schematic diagram illustrating operation of a stud welding tip used in a stud welding device according to an exemplary embodiment of the present invention.

FIG. 7 is a flowchart of a welding method performed by using a stud welding device according to an exemplary embodiment of the present invention.

FIG. 8 is a perspective view of a welding portion that is welded by a stud welding device according to an exemplary embodiment of the present invention.

<Description of symbols>

| | |
|---|---|
| 1: stud welding tip | 5: cooling holder |
| 7: pressing cylinder | 9: electric cable |
| 10: stud bolt | 10a: head portion |
| 10b: bolt portion | 11: gun frame |
| 13: transformer | H1: inserting hole |
| H2: negative pressure path | 20: vacuum pump |
| 21: negative pressure pipe | 30: jig |
| 40: base metal | W: welding portion |

### DETAILED DESCRIPTION OF THE EMBODIMENTS

Exemplary embodiments of the present invention will hereinafter be described in detail with reference to the accompanying drawings.

Since size and thickness of each component illustrated in the drawings are arbitrarily represented for ease of explanation, the present invention is not limited to the drawings. Thicknesses of many parts and regions are enlarged.

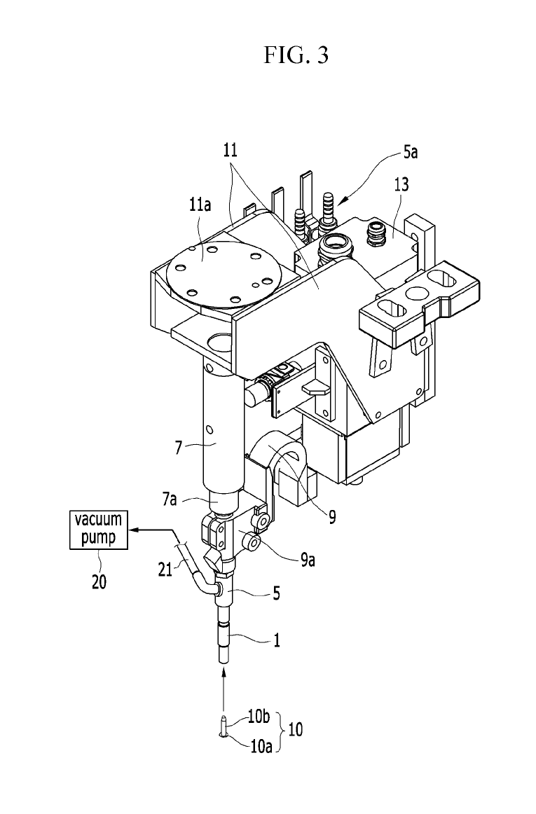

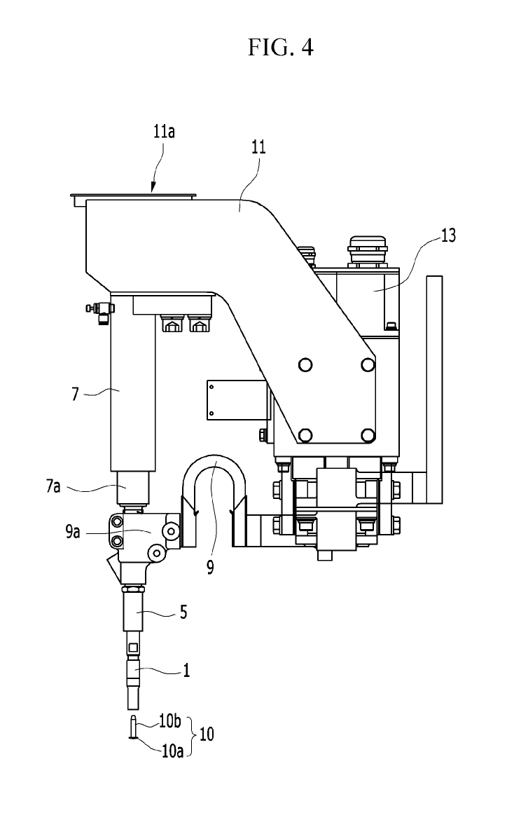

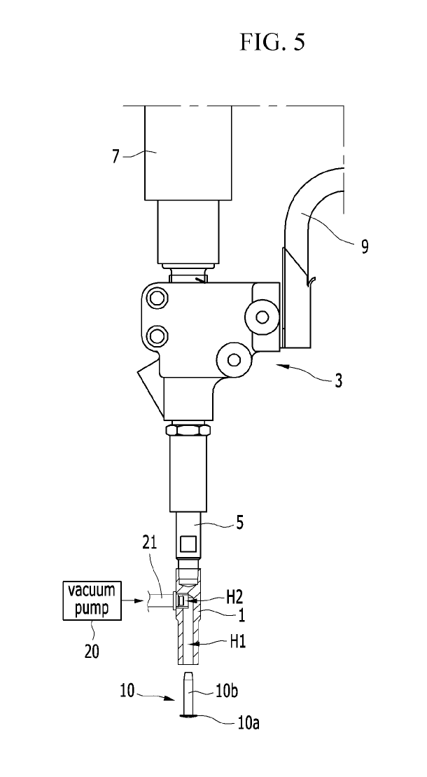

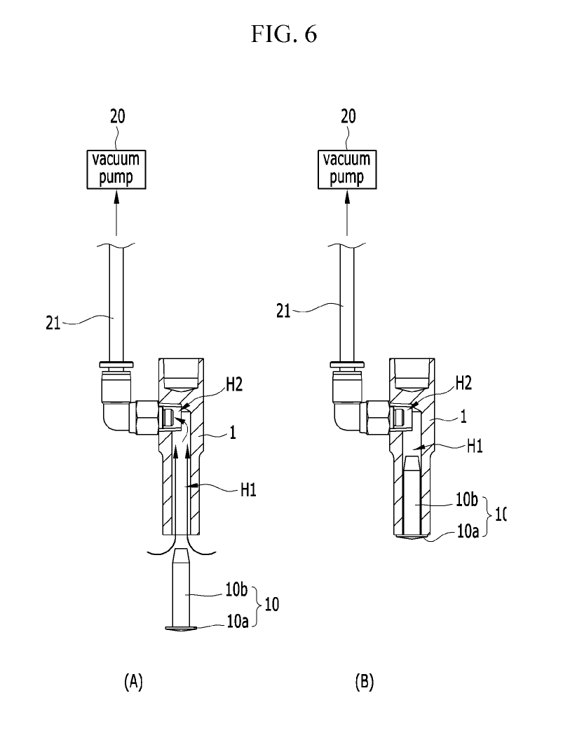

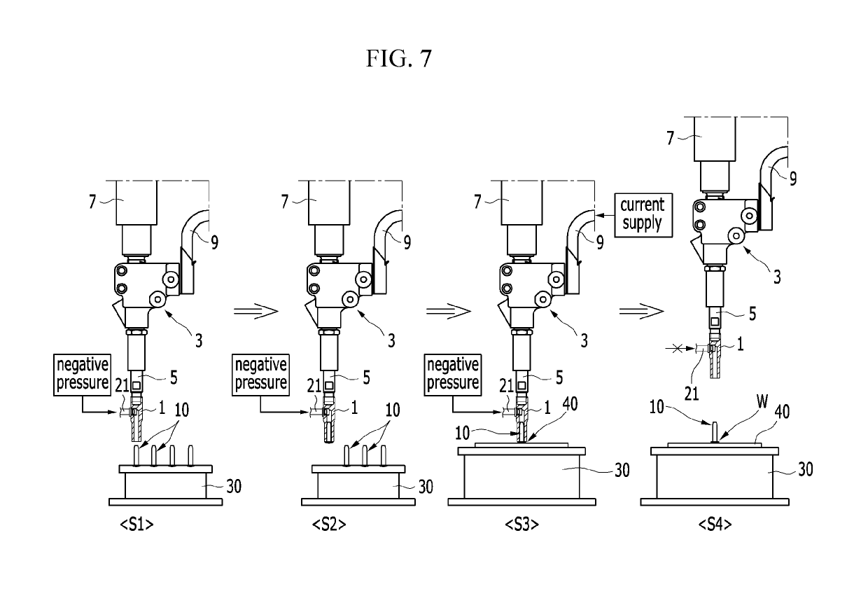

FIG. 3 is a perspective view of a stud welding device according to an exemplary embodiment of the present invention; FIG. 4 is a side view of a stud welding device according to an exemplary embodiment of the present invention; FIG. 5 is a partial side view of a stud gun used in a stud welding device according to an exemplary embodiment of the present invention; FIG. 6 is a schematic diagram illustrating operation of a stud welding tip used in a stud welding device according to an exemplary embodiment of the present invention; and FIG. 7 is a flowchart of a welding method performed by using a stud welding device according to an exemplary embodiment of the present invention.

Referring to FIG. 7, a stud welding device according to an exemplary embodiment of the present invention bonds a head portion 10a of a stud bolt 10 to a welding portion by applying pressure and current to a base metal in a state of mounting the stud bolt 10 at a stud welding tip 1 using negative pressure. According to an exemplary embodiment of the present invention, soot occurrence on the base metal 40 may be minimized.

Referring to FIG. 3 and FIG. 4, the stud welding device includes a gun frame 11, a transformer 13, a pressing cylinder 7, a cooling holder 5, the stud welding tip 1, and an electric cable 9.

A mounting surface 11a is formed at an upper portion of the gun frame 11 and is mounted at an arm of a robot (not shown).

The transformer 13 is mounted at a side of a rear portion of the gun frame 11 and supplies welding current.

The pressing cylinder 7 is mounted vertically at a front portion of the gun frame 11 and includes an operating rod 7a. The operating rod 7a is disposed downwardly at a lower portion of the pressing cylinder 7.

The pressing cylinder 7 may be a hydraulic cylinder but is not limited thereto.

In addition, the cooling holder 5 is mounted at a front end of the operating rod 7a of the pressing cylinder 7, receives coolant from a coolant pipe 5a provided at a side surface of the gun frame 11, and supplies the coolant to the stud welding tip 1.

Referring to FIG. 5 and FIG. 6, the stud welding tip 1 is mounted at a front end of the cooling holder 5 and is formed of an inserting hole H1 in which negative pressure is applied. A lower portion of the inserting hole H1 is open and a stud bolt 10 can be inserted into the inserting hole H1.

An upper end of the stud welding tip 1 is press-fitted and fixed to the front end of the cooling holder 5, and the stud welding tip 1 is cooled by the coolant supplied from the cooling holder 5.

In addition, a negative pressure path H2 connected to the inserting hole H1 is formed in the stud welding tip 1, and negative pressure can be formed quickly in the inserting hole H1 through the negative pressure path H2

The negative pressure path H2 formed in the stud welding tip 1 is connected to an exterior vacuum pump 20 through a negative pressure pipe 21.

In addition, a front end surface of the stud welding tip 1 contacts with a head portion 10a of the stud bolt 10 such that the head portion 10a of the stud bolt 10 mounted in the inserting hole H1 by suction force of the negative pressure in the inserting hole H1 blocks the inserting hole H1. Therefore, vacuum pressure is formed in the inserting hole H1.

That is, a bolt portion 10b at an upper portion of the stud bolt 10 is positioned near the inserting hole H1 of the stud welding tip 1 (please refer to (A) in FIG. 6), the bolt portion 10b is inserted into the inserting hole H1 by the suction force of the negative pressure. After the bolt portion 10b is inserted into the inserting hole H1, the head portion 10a of the stud bolt 10 blocks the inserting hole H1 such that the stud bolt 10 is held in the stud welding tip 1 by the vacuum pressure formed in the inserting hole (please refer to (B) in FIG. 6).

In addition, the electric cable 9 is connected to the operating rod 7a of the pressing cylinder 7 through a cable holder 9a and is adapted to apply current of the transformer 13 to the stud welding tip 1.

The stud welding device according to the exemplary embodiment of the present invention execute resistance welding by applying pressure and current to the base metal 40 in a state that the stud bolt 10 is mounted at the stud welding tip 1 by using the negative pressure formed in the inserting hole H1 of the stud welding tip 1.

Hereinafter, referring to FIG. 7, a welding method according to an exemplary embodiment of the present invention will be described in detail.

Referring to FIG. 7, the welding method according to the exemplary embodiment of the present invention begins with step S1. At the step S1, the vacuum pump 20 is operated and the negative pressure is formed quickly in the inserting hole H1 of the stud welding tip 1.

After that, the front end of the stud welding tip 1 including the inserting hole H1 in which the negative pressure is formed is positioned above any one stud bolt 10 among a plurality of stud bolts 10 disposed in parallel with each other on a jig 30. In this case, the stud bolt 10 is pulled into and is mounted in the inserting hole H1 through the front end of the stud welding tip 1 at step S2.

Herein, the plurality of stud bolts 10 on the jig 30 is so disposed that the head portion 10a of each stud bolt 10 is positioned downwardly, and is disposed apart from each other by a predetermined distance on the jig 30.

Therefore, the bolt portion 10b of the stud bolt 10 is inserted into the inserting hole H1 of the stud welding tip 1 by the suction force due to the negative pressure. In addition, after that the stud bolt 10 is inserted into the inserting hole H1, the head portion 10a of the stud bolt 10 blocks the inserting hole H1 and the stud bolt 10 is held in the stud welding tip 1 by the vacuum pressure formed in the inserting hole H1.

After that, the head portion 10a of the stud bolt 10 mounted in the stud welding tip 1 is positioned corresponding to the welding portion W of the base metal 40 by movement of the robot.

At this state, the pressing cylinder 7 moves downwardly such that the head portion 10a of the stud bolt 10 is pressed onto the welding portion W of the base metal 40 and welding current is applied to the welding portion W of the base metal 40 through the electric cable 9. Therefore, the head portion 10a of the stud bolt 10 is deposited and bonded onto the base metal 40 by resistance heat. That is, resistance welding with pressure is performed at step S3.

After the resistance welding with pressure is completed, the pressing cylinder 7 moves upwardly and the robot lifts the stud welding tip 1 from the stud bolt 10 at step S4. After that, the welding device is moved to a next work station.

Meanwhile, the stud welding tip 1 is cooled by coolant in a state of being mounted at the cooling holder 5 such that overheating due to welding heat may be prevented.

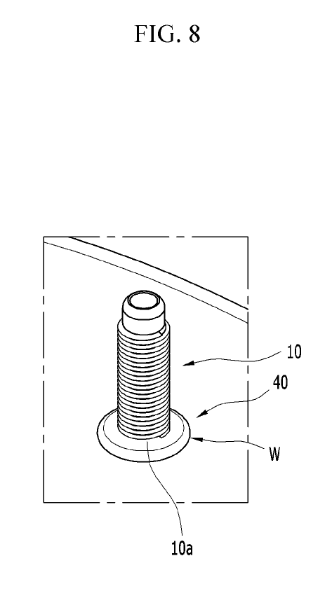

FIG. 8 is a perspective view of a welding portion that is welded by a stud welding device according to an exemplary embodiment of the present invention.

Referring to FIG. 8, if the stud bolt 10 is welded to the base metal 40 using the stud welding device, the head portion 10a of the stud bolt 10 is quickly deposited onto the surface of the base metal 40 by the resistance heat. Therefore, occurrence of soot around the welding portion W may be minimized.

Since the stud welding device according to an exemplary embodiment of the present invention mounts the stud bolt 10 to the stud welding tip 1 by the negative pressure when welding the stud bolt 10, additional devices for supplying the stud bolt 10 may not be required.

In addition, since resistance welding is done by applying pressure and current to the base metal 40, soot occurrence on the base metal 40 may be minimized, painting and appearance quality of the base metal may be improved, and welding strength may also be improved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A stud welding device comprising:
a gun frame;
a transformer disposed at a side of a rear portion of the gun frame and supplying welding current;
a pressing cylinder mounted at a front portion of the gun frame and including an operating rod;
a cooling holder mounted at a front end of the operating rod of the pressing cylinder;
a stud welding tip mounted at a front end of the cooling holder and formed of an inserting hole in which negative pressure is applied; and
an electric cable connected to one side of the operating rod of the pressing cylinder and applying the current of the transformer to the stud welding tip,
wherein the stud welding device is adapted to execute resistance welding by applying pressure and the current to the base metal in a state of mounting a stud bolt at the stud welding tip using the negative pressure in the inserting hole.

2. The stud welding device of claim 1, wherein the inserting hole of the stud welding tip is connected to a negative pressure path so as to form the negative pressure therein.

3. The stud welding device of claim 2, wherein the negative pressure path is connected to a vacuum pump through a negative pressure pipe.

4. The stud welding device of claim 1, wherein a front end surface of the stud welding tip is closed by a head portion of the stud bolt such that vacuum pressure is formed in the stud welding tip.

5. The stud welding device of claim 1, wherein the stud welding tip is cooled by coolant supplied from the cooling holder.

6. The stud welding device of claim 1, wherein the stud welding tip is press-fitted into a front end of the cooling holder.

7. A welding method comprising:
forming negative pressure in a stud welding tip mounted at a front end of a stud welding gun;
mounting the stud bolt at a front end of the stud welding tip by positioning the front end of the stud welding tip in which the negative pressure is formed above the stud bolt;
positioning the stud bolt mounted at the stud welding tip on a welding portion of a base metal to which the stud bolt will be bonded; and
bonding a head portion of the stud bolt to the base metal by resistance heat by pressing the head portion of the stud bolt onto the welding portion of the base metal and applying current thereto.

8. The welding method of claim 7, wherein the stud welding tip is formed of an inserting hole having an opened lower portion into which the stud bolt is inserted, and the inserting hole is connected to a negative pressure path so as to form the negative pressure therein.

9. The welding method of claim 8, wherein the negative pressure path is connected to an exterior vacuum pump.

10. The welding method of claim 8, wherein the head portion of the stud bolt that is mounted at the inserting hole by suction force of the negative pressure closes the inserting hole such that the stud welding gun holds the stud bolt by vacuum pressure formed in the stud welding gun.

11. The welding method of claim 7, wherein the stud welding tip is mounted at a cooling holder provided at a front end of the stud welding gun and is cooled by coolant.
